(19) United States
(12) Patent Application Publication
(10) Pub. No.: US 2003/0051246 A1
(43) Pub. Date: Mar. 13, 2003

(54) System and method for combining several EPG sources to one reliable EPG

(76) Inventors: John Richard Wilder, Sand Breugel (NL); Ronald Marcel Tol, Eindhoven (NL); Eric Hendrik Jozef Persoon, Eindhoven (NL)

Correspondence Address: U.S. Philips Corporation, 580 White Plains Road, Tarrytown, NY, 10591, US

(21) Appl. No.: 10/210,476

(22) Filed: Aug. 1, 2002

(30) Foreign Application Priority Data
Aug. 6, 2001 (EP) 01202962.5

(51) Int. Cl. G06F 3/00; H04N 5/445; G06F 13/00

(52) U.S. Cl. 725/49; 725/48; 725/44; 725/59

(57) ABSTRACT

The present invention relates to a device for acquiring electronic program guide (EPG) data from a plurality of different EPG sources (120), and combining the acquired data to a single EPG (10). At regular intervals, EPG data is acquired from different sources (120), which may include the Internet (122), digital programming broadcasters, and teletext service providers (126). Equivalent program listings (40) within the acquired EPG data are identified, and the best information is selected from the equivalent program listings (40) to be included in the combined EPG (10). The present invention is able to identify equivalent program listings (40), even if the program titles are written in different languages or when the scheduled broadcast times differ to some extent. The resulting EPG (10) is more reliable and contains more information than any of the EPGs (10) associated with the original sources (120).

### FIELD OF THE INVENTION

The present invention relates to an electronic guide program (EPG), and more specifically to a system that extracts and combines EPG information from a plurality of sources to create a more reliable EPG.

### DESCRIPTION OF THE PRIOR ART

In the last twenty years, the number of programming choices available to television viewers has increased dramatically, due to the advent of broadcast technologies such as cable, satellite, and other digital television systems. Today, many television viewers may choose from hundreds of television channels. Furthermore, television is no longer the only medium for broadcasting programs. Internet webcasts, in which data streams conveying multimedia programs are broadcast to a plurality of personal computers, are becoming increasingly popular.

Printed program guides, such as those published in newspapers and periodicals are generally not adequate to provide a viewer with all of the information needed to choose from such a wide variety of television channels. A limited amount of space is provided on which such guides can be printed. Accordingly, printed program guides cannot include programming information on every available channel. The space limitation associated with printed guides also limits the amount of information that can be presented for each show. For example, only program titles, start times, and stop times may be printed. Furthermore, printed program guides may contain inaccurate programming information, if changes to the programming schedule have been changed after publication are published. Also, television viewers may become frustrated when they mislay or inadvertently throw away their program guides.

To overcome these disadvantages, electronic program guides (EPGs) have been developed. EPGs are available from many different sources. EPGs can be accessed from the Internet, for example, by using a web browser on a personal computer to view an EPG provided on a web site. In addition, EPGs can be transmitted directly to a viewer's television from digital television broadcasters through the same transmission medium as the television programs. Such EPGs include Digital Video Broadcasting Service Information (DVB-SI) provided by digital broadcasters in Europe, and programming information transmitted in accordance with the Program and System Information Protocol (PSIP) standard used by ATSC Digital Television broadcasters in the United States. In addition, program schedule information can be provided from commercial text service providers, such as teletext.

EPGs do not suffer from space constraints associated with printed programming guides. Since EPG data is stored electronically, a vast amount of EPG information can be stored within one source. In addition, an EPG can be constantly updated to reflect changes in the programming schedule. Also, an EPG may convey a very detailed description of each program listed, including a synopsis of the program, the actors featured, the running time, category or genre, and information on whether the program is acceptable for all audiences or only for mature audiences. Since a large amount of programming information can be stored, EPG information is usually classified, or sorted, in accordance with its genre or theme. This allows a viewer to specify a type of program that he or she is interested in, and view only those program listings that fit the viewer's specified type.

As discussed above, a wide variety of EPGs are available to viewers, and the amount of information covered by different EPGs may be quite different. For example, some EPG sources may give program information weeks in advance, while others only provide information for the current day. Also, some EPG sources give extensive channel coverage while others are more limited. However, the EPG source that provides limited channel coverage may include much more descriptive information concerning each program than does the EPG source covering more channels. Some EPG sources may be updated more frequently, and may therefore be more reliable, than other sources. Furthermore, some EPG sources contain information in a language that a viewer may not understand.

Consequently, a viewer who relies on EPG information from only one source may encounter a number of problems. Such problems may include: limited channel coverage; limited time period coverage; short or non-existent program descriptions; unreliable program information; program descriptions written in an unfamiliar language; program listings left undefined, or doubly defined, for a given time interval; category, or genre, information not directly available; or unavailable Program Delivery Control (PDC) information, which is used by video recorders to record specific programs.

### OBJECT AND SUMMARY OF THE INVENTION

The present invention overcomes the above-mentioned problems of using an EPG from a single source. Specifically, the present invention combines EPG information obtained from a plurality of different sources into a single EPG. In the present invention, the resulting EPG is more comprehensive than the EPG information stored in any one of the originating sources from which EPG information is obtained. The present invention also provides an improved categorization of program listings in an EPG, by determining relevant keywords in the title and the description of each program listing, and defining categories for each program based on the keywords.

One embodiment is an EPG device that acquires EPG information from a plurality of different EPG sources, or providers, at regular intervals and writes the acquired EPG information to a database. The EPG device further searches the database to identify equivalent program listings from each EPG source and generates a combined EPG by combining equivalent program listings. The combined EPG is output to a viewer in a visual or audio format.

In another embodiment of the present invention, a first algorithm is executed in the EPG device that identifies a set of equivalent program listings from different EPG sources, based in part on identifying program listings whose start times fall within a specified time window.

In another embodiment of the present invention, a second algorithm is executed in the EPG device that identifies equivalent program listings from different EPG sources, whose start times do not fall within a specified time window, based in part on identifying program listings whose scheduled running times overlap with each other by more than a given fraction.

In another embodiment of the present invention, a set of equivalent program listings is combined by determining and extracting the best information about the corresponding program from the program listings, and combining and formatting the extracted information into a combined EPG program listing for the program. The resultant set of combined EPG program listings make up a combined EPG that is output to the viewer.

In another embodiment of the present invention, when equivalent program listings contain conflicting information items, the EPG device determines which of the conflicting information items is the best according to a set of criteria, including the amount of information and reliability of information conveyed in each conflicting information item.

In another embodiment of the present invention, the EPG device searches the program titles and descriptions of the combined program listing for relevant keywords, and defining categories into which the combined program listing can be classified in accordance with these keywords.

In another embodiment of the present invention, the program listings in the combined output EPG may be presented to the viewer in alternate languages, as requested by the viewer.

Another embodiment of the present invention is directed to a method of acquiring EPG data from a plurality of EPG sources, generating a combined EPG from program listings of the acquired EPG data, and outputting the combined EPG to a viewer in a visual or audio format.

Another embodiment of the present invention is software executed on a computer for acquiring EPG data from a plurality of EPG sources, generating a combined EPG from program listings of the acquired EPG data, and outputting the combined EPG to a viewer in a visual or audio format.

### BRIEF DESCRIPTION OF THE DRAWINGS

It is to be understood that these drawings are designed for purposes of illustration only and not as a definition of the limits of the invention for which reference should be made to the appendent claims.

FIG. 1 is an illustration of an electronic program guide.

FIGS. 2 and 3 are block diagrams illustrating the configuration of a system for acquiring and combining EPG data from different sources to generate an EPG.

FIG. 4 is a flowchart illustrating the method wherein EPG data from different sources is acquired and combined into a single EPG.

FIG. 5 is a flowchart illustrating the algorithm for identifying equivalent program listings in accordance with the start times of the programs.

FIG. 6 is a flowchart illustrating the algorithm for identifying equivalent program listings in accordance with an overlap in running time of the programs.

### DESCRIPTION OF EMBODIMENTS

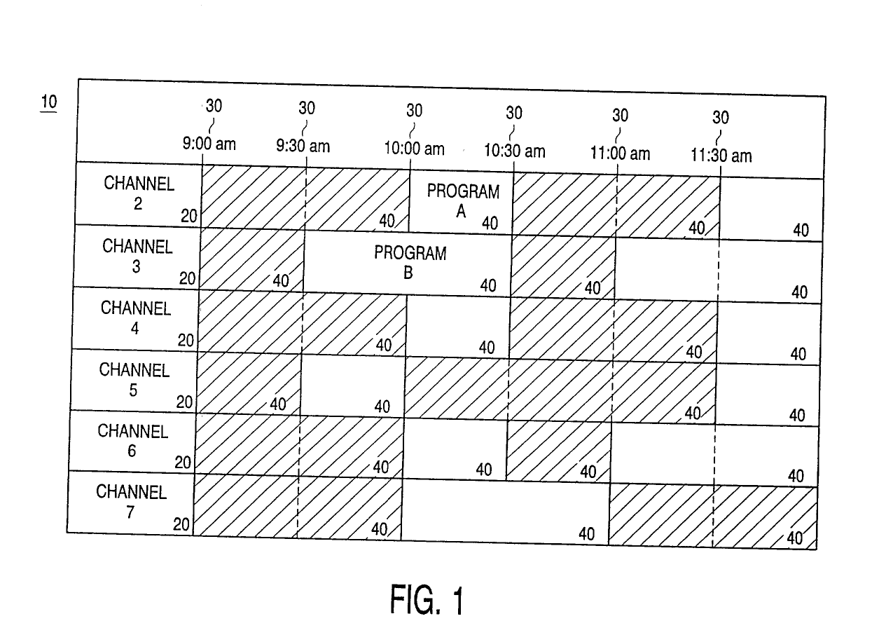

Referring to the drawings, FIG. 1 shows an embodiment of an electronic program guide (EPG) 10. An EPG 10 usually displays one or more program listings 40, each of which provides information regarding a particular program to be broadcast through a communication medium to a plurality of output devices. The information provided by a program listing usually includes at least the title of the program. This information may also include the running time of the program, the actors featured in the program, a synopsis of the program, the genre or category relating to the program, and other information that describes the content of the program.

An EPG 10 may include program listings for television programs, webcasts, or radio programs. As discussed above, television programs may be transmitted via television antenna signals, cable, satellite, or other types of communication media. Radio programs may be broadcast via radio signals or, in some cases, over the Internet to a personal computer. Webcasts, which include multimedia data streams that are viewed on personal computers, are broadcast over the Internet or other computer networks.

Generally, the EPG 10 is formatted in such a way that the program listings 40 are displayed in accordance with the scheduled broadcast time and the specific channel through which the program will be on the air. The EPG 10 of FIG. 1 shows that program listings 40 can be displayed in a table or grid, which is divided horizontally into with scheduled times 30 (e.g., every hour and half-hour during the day), and is divided vertically into different channels 20. For example, the EPG 10 of FIG. 1 shows that Program A will be on the air between 10:00 a.m. and 10:30 a.m. on channel 2, while Program B will be on the air between 9:30 a.m. and 10:30 a.m. on channel 3.

However, an EPG 10 can be displayed in many different formats, where each format covers a different range of program listings 40. For example, the EPG 10 may only display program listings 40 on a channel 20, time 30, or category/genre specified by a user. Also, the EPG 10 may either show the program listings corresponding to every channel at one time, or may slowly scroll through the program listings for each channel so that only the program listings of a subset of channels 20 can be viewed on the screen at one time. Similarly, the EPG 10 may display the program listings for all scheduled times 30 during a particular day, or only the program listings 40 corresponding to programs may be on the air at a current time.

As mentioned above, many different EPGs 10 are available from many different sources. These sources include digital television broadcasters (e.g., a digital cable programming provider or a satellite signal provider), which transmit EPGs 10 directly to subscribers' television sets in the form of DVB-SI (Europe) or PSIP data (United States). Other sources include commercial teletext services, which also transmit EPGs 10 directly to the televisions of customers. Additional sources of EPGs 10 are accessible via the Internet, such as websites on the Worldwide Web that transmit EPG data to personal computers to be viewed, using web browsers. Of course, EPG data may be accessed from other sources as well, as will be known to those skilled in the art.

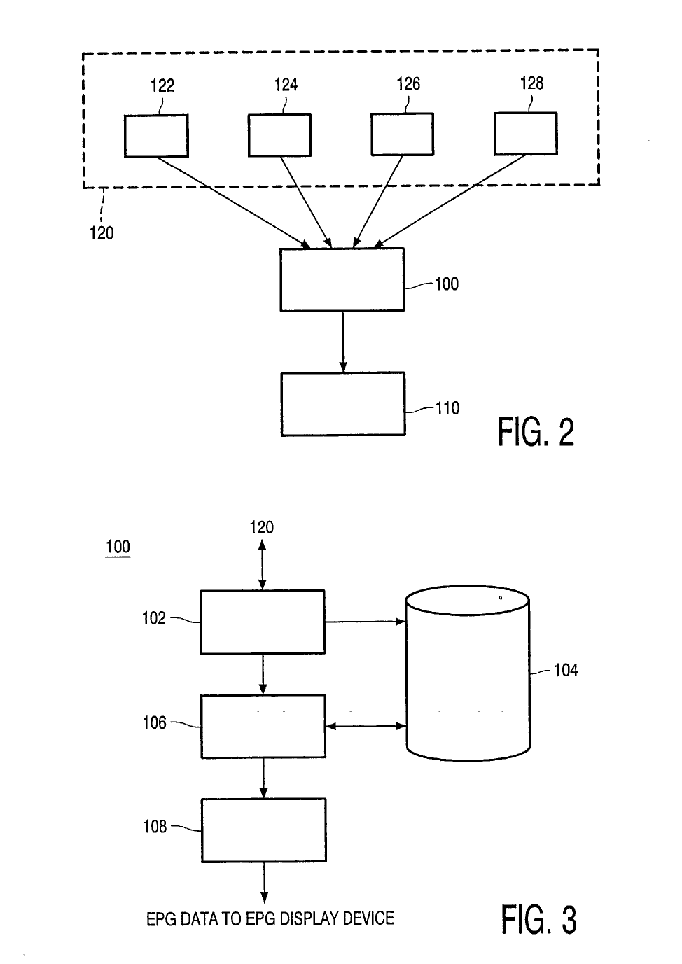

FIG. 2 shows a configuration of a system for acquiring EPG data from a plurality of different sources and combining the acquired data to generate a single EPG 10, in accordance with an embodiment of the present invention. An EPG generating device 100 acquires EPG data from a plurality of sources 120, and combines the EPG data to generate a single EPG, which is displayed on EPG output device 110. As already mentioned, the EPG data sources may include different sources on the Internet 122, digital television broadcasters providing DVB-SI or PSIP data 124, teletext service providers 126, and other sources 128.

In one embodiment, the EPG output device 110 is a television, and the EPG generating device 100 may be included in a central broadcasting station that transmits an EPG 10 to the television. Alternatively, the EPG generating device may be a local device such as a stand-alone device, a set-topbox, or a device having other functions, such as a video cassette recorder (VCR), a set-top box for changing the television channel, or the television itself.

In another embodiment, the EPG output device 110 may be a computer output device. In this embodiment, the EPG generating device 100 may comprise a central server, from which EPG data is downloaded to a user's personal computer. Otherwise, the EPG generating device 100 may be configured as a peripheral device internally or externally connected to a computer and/or a software application being executed by a computer processor. In addition, the EPG output device 110 may be a peripheral device connected to a computer, such as a printer.

However, the EPG output device 110 is not limited to visual output devices. In another embodiment, the information contained in an EPG 10 may be output as synthesized or recorded speech signals emanating from an EPG output device 110 embodied as an audio output device, such as television speakers, speakers on a computer, or a radio.

It should be noted that in any of the above embodiments, the EPG generating device 100 may be configured as either hardware or as a combination of hardware and software being executed by a processor. The detailed components of the EPG generating device 100 are illustrated by the block diagram in FIG. 3. It will be clear to those of ordinary skill that any one of unit blocks 102, 104, and 106 may illustrate either a hardware-based device/component or a functional block of an executable computer program. However, the block diagram of FIG. 3 is only illustrative and should not be construed as limiting. Those of ordinary skill will realize that functions of multiple unit blocks shown in FIG. 3 may be combined into a single hardware component or block of computer program instructions. Likewise, those of ordinary skill will realize that functions that are ascribed to a single unit block in FIG. 3 may be performed by separate hardware components or software blocks.

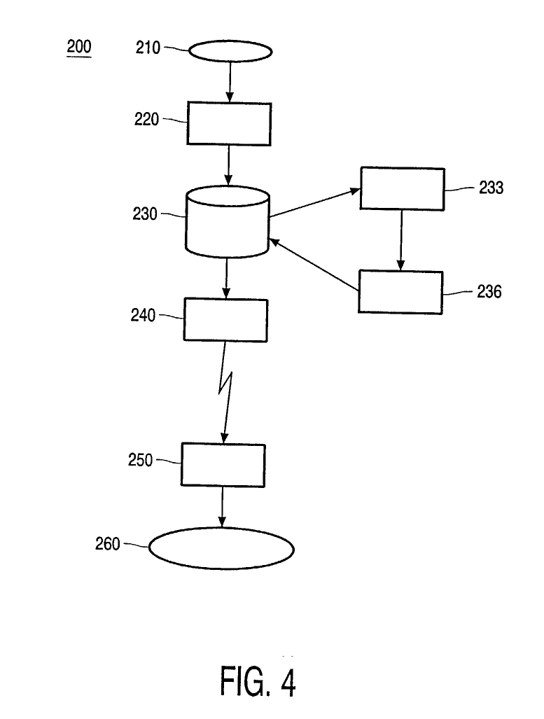

The operation of the EPG generating device 100 will now be described with reference to the block diagram of FIG. 3 and the flowchart 200 of FIG. 4. An acquiring unit 102 acquires or extracts EPG data from a plurality of EPG data sources 120. In one embodiment, the acquiring unit 102 sends a request signal at regular defined intervals (e.g., every two hours) to a plurality of known EPG data sources 120. These EPG data sources may be registered in a table or data structure within the acquiring unit 120. In another embodiment, however, each EPG data source 120 may be configured to automatically send EPG data to the acquiring unit 102 after every update of the source 120. Or else, in another embodiment, the acquiring unit 102 may send a query to each EPG data source 120 to determine whether the source 120 has been updated since the last acquisition of EPG data from that source 120. If the EPG data source 120 has been updated since the last acquisition, the acquiring unit may request that the updated EPG data be transmitted. Step 210 of FIG. 4 illustrates the acquisition of EPG data from an Internet source 122.

After acquisition, the acquired EPG data must be parsed and interpreted (as illustrated in step 220 of FIG. 4) and translated into a suitable data format by the acquiring unit 102. The acquiring unit writes the translated EPG data to a database 104 (step 230 of FIG. 4). The database 104 comprises any organized collection of the EPG data stored in a data storage medium. The database 104 may be embodied as a tabular database, relational database, object-oriented database, spreadsheet, or any other type of application that imparts some type of organization on the data, allowing it to be accessed, managed, and updated.

The identifying unit 10 accesses the EPG data written to the database 104 in order to identify all program listings from the plurality of sources 120 that correspond to the same broadcast program (as depicted in step 233 of FIG. 4). The identifying unit determines multiple sets of program listings that are determined to be equivalent, i.e., providing information relating to the same broadcast program. Each set of equivalent program listings 40 corresponds to a single program listing 40 that will be included in the EPG 10 generated by the EPG generating device.

The identifying unit 10 sends the sets of equivalent program listings 40 to the combining unit 108. The combining unit 108 processes each set of equivalent program listings 40 in order to determine the best information corresponding to the program, as illustrated in step 236 of FIG. 4. In order to determine the best information within a set of equivalent program listings 40, the combining unit must examine the information items contained within each program listing 40.

Certain types of data items contained in equivalent program listings 40 will usually be very similar. Data items such as program title, start and end times of the program, and the channel on which the program will broadcast may be almost identical in equivalent program listings 40. However, other data items, such as description or synopsis of the program, are subjective and may therefore be very different in each program listing 40. In addition, some program listings may include types of data items not included in other equivalent programs, depending on the source of the program listing 40. For instance, PDC (Program Delivery Control) information may be included only in program listings acquired from teletext providers.

The data items included in a generated EPG will generally include each data item contained in the corresponding set of equivalent program listings 40. If at least one program listing contains a data item, it will automatically be included in the generated EPG 10 by the combining unit 108.

When more than one program listing 40 contains a particular data item, the combining unit 108 may use different criteria to determine the best information to be included for this data item of the generated EPG 10. For example, in choosing the best program synopsis or description, the most detailed or informative synopsis may be chosen by the combining unit 108 from the set of equivalent program listings 40. Likewise, for choosing the best data item corresponding to the featured actors in the program, the data item that lists most actors may be chosen. Therefore, the amount of information may be one criterion used by the combining unit 108.

In the situation where different program listings 40 contradict each other as regards a data item, the combining unit 108 may determine the best data item by determining which data item is agreed upon by the majority of program listings. Furthermore, the combining unit 108 may choose the best data item based on the reliability of the sources 120 of the program listings 40. For example, an EPG source 120 that is updated more recently or more frequently than other sources 120 may be determined to be more reliable by the combining unit 108. Therefore, the combining unit 108 may be configured to choose data items from the most recently updated EPG source 120. The reliability of an EPG source 120 may also be determined from other factors. For example, the combining unit 108 may keep track of the numbers of errors contained in program listings from each EPG source 120.

The combining unit 108 may use other criteria as well, such as the geographical location that the generated EPG 10 will use. For example, the combining unit 108 may not include data items from equivalent program listings 40 that are written in a language that is not commonly used in the area where the television viewer lives.

Algorithm 200 shows an embodiment in which the EPG generating device 100 is located at a central location, such as a broadcasting station or server, and the generated EPG 10 is broadcast or transmitted to a plurality of EPG output devices 110. In this embodiment, after the combining unit has determined the best information to be included in each program listing 40, the program listings 40 are formatted and combined into a single data structure, or generated EPG, that is stored in a server. The generated EPG 10 is then broadcast or transmitted to a plurality of remote stations, as shown in steps 250. Each EPG output device 110 then outputs the generated EPG 10, as illustrated in step 260.

However, in another embodiment, the EPG generating device may be integrated in a local device, such as a set-top box, VCR, or as a program being executed on the personal computer. In this embodiment, steps 240 and 250 are replaced with a step that stores the generated EPG 10 in a local memory or data storage device.

The operation of the identifying unit 106 will now be described in more detail. The identification of equivalent program listings 40 is not a trivial task. Even though program listings 40 from different sources 120 provide information related to the same program, the program titles provided by each program listings 40 may differ.

For example, one program listing may include articles such as “A” and “The” at the beginning of the program title, while another program listing does not. In addition, a program listing may misspell a word within the program title. Also, program listings 40 from different sources may be written in different languages.

Additionally, program listings 40 of different sources that correspond to the same program may also differ according to the channel listing for the program. For example, one program listing may include the channel number on which the program will be aired, while another program listing may include the name or call letters of the station that is broadcasting the program, instead of a channel number. Such a situation may arise when an EPG for a particular source covers a local region, which only lists local channel numbers, while another source contains an EPG to be used in multiple regions throughout the country, which lists names of network stations that broadcast to different channel numbers depending on the region. Similarly, EPG sources that service different broadcast providers (e.g., different cable companies or satellite systems) may broadcast the same programs via different channel numbers.

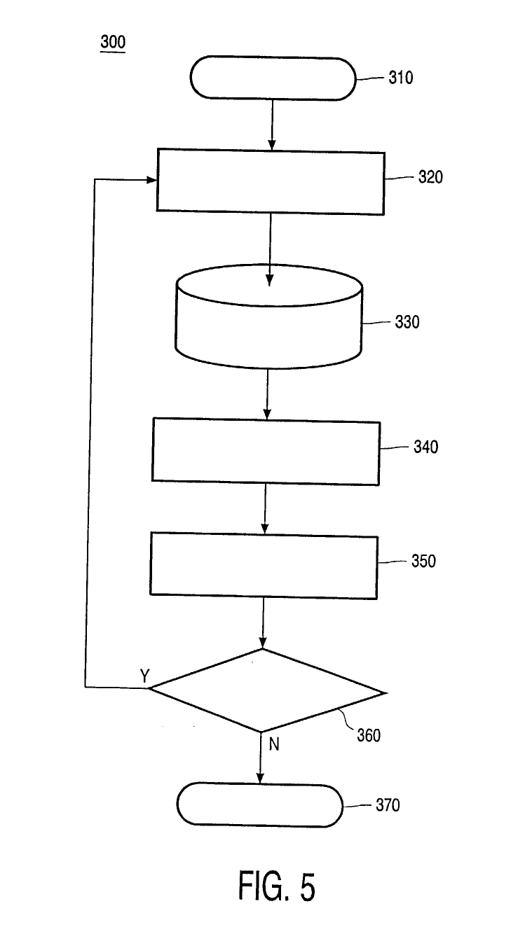

Therefore, in an embodiment of the present invention, the identifying unit 106 executes an algorithm in which program listings can only be determined as being equivalent if the scheduled start time of each program listing falls within a specified time window. An example of such an algorithm is illustrated by the flowchart of FIG. 5.

In step 310, a scheduled time range to be covered by the generated EPG 10 is specified. This time range spans from a beginning date and time to an ending date and time. In an embodiment, the length of the time range may remain constant whenever an EPG 10 is generated by the EPG generating unit 100 (e.g., always spanning four hours from the most recently passed hour or half-hour 30). In another embodiment, the user may specify the time interval to be covered by the generated EPG 10, using an input device (e.g., keyboard, remote control, etc.). After determining the time range, the identifying unit 106 determines the first scheduled time 30 of the time range. It should be noted, especially in cases where the time range spans multiple dates, that each scheduled time may correspond to a specific date and time. As discussed hereinbefore, each scheduled time 30 usually corresponds to the start of each hour and thirty minutes past each hour. However, the scheduled times 30 of an EPG may alternatively occur only at the start of each hour, or for each fifteen minute interval (e.g., 9:00, 9:15, 9:30 . . . ), or for any other division of time within the time range.

Since program start and end times of equivalent program listings from different sources may vary by up to several minutes, a time window is determined for each scheduled time in step 320. The time window is the interval of time that starts a specified amount of time ΔT (e.g., five minutes) before and after the scheduled time. In the next step 330, the database 104 in accessed to identify all program listings in the EPG data in the database (acquired from the plurality of sources) whose start time occurs within the specified time window.

For example, these program listings can be identified by generating a database query for all database records corresponding to program listings whose start date and time parameters fall within the range of values specified by the time window. However, those of ordinary skill will be able to contemplate the different methods and commands for accessing such program listings from a database of EPG data, all of which fall within the scope of the present invention.

In step 340, the program listings 40 identified in step 330 are further analyzed to sort them into sets of equivalent program listings. The program title, program description, and/or genre of each identified program listing 40 may be analyzed, and the program listings 40 can be sorted into sets of equivalent program listings 40 based on the similarity of these fields. Similarity between text fields (e.g., program title, program description, or genre) may be performed by using artificial intelligent techniques, such as algorithms that perform partial string matching between text fields. Such techniques may be used to generate a score or value, which represents a similarity between multiple text fields or a confidence that the text fields correspond to the same program. Any one of a plurality of techniques or algorithms for determining a degree of similarity between text fields, which are known to those of ordinary skill, may be performed in order to determine equivalent program listings 40 in the present invention.

Also, other data items, such as channel listings, corresponding to the identified program listings 40, can be used to determine which program listings 40 are equivalent. Furthermore, the specified end time in the identified program listings 40 may be used to help determine which program listings 40 are equivalent. In one embodiment, one or more of the program titles, program description, genre, channel listing, and end time of each identified program listing 40 is used to determine which program listings are equivalent, i.e., which program listings correspond to the same programs.

In step 350, the next scheduled time is determined by incrementing the present scheduled time by a predetermined amount (e.g., thirty minutes). Next, in step 360, it is determined whether the new scheduled time is within the scheduled time range being considered for the generated EPG 10. If the scheduled time is within the time range, the algorithm returns to step 320 to determine equivalent program listings 40 for this scheduled time. If the scheduled time is no longer within the time range, the determined sets of equivalent program listings are sent to the combining unit 108, which uses these program listings to generate an EPG 10.

It should be noted that the algorithm 300 of FIG. 5 may fail to identify certain program listings 40 as equivalent to other program listings 40, if the start times of these program listings do not fall within the same time window. In this situation, the combining unit 108 may generate multiple program listings corresponding to the same program, thereby causing program overlap in the generated EPG.

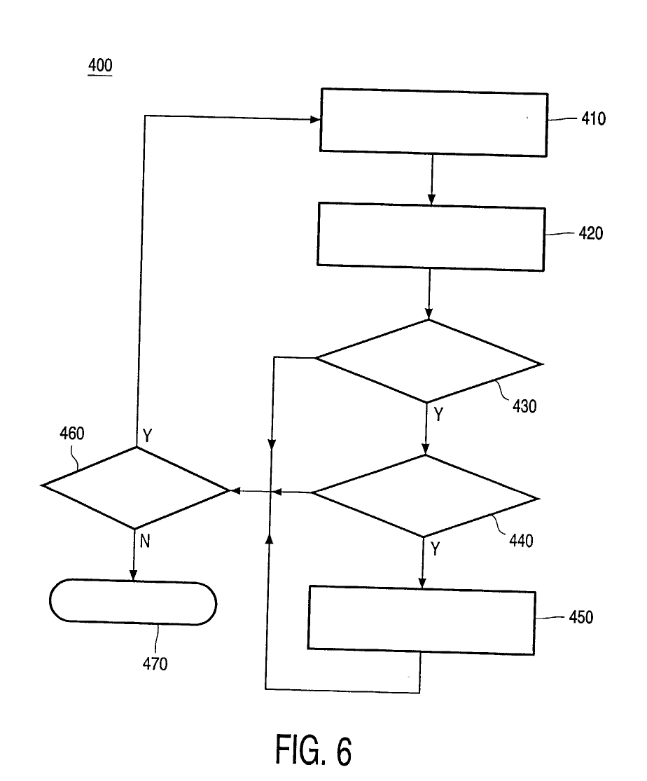

In another embodiment, the identifying unit 106 executes a second algorithm 400, as illustrated in FIG. 6. In step 410 a program listing 40 whose start date and time fall within the scheduled time range, but not within any of the time windows determined in algorithm 300, is determined. In step 420, the start and end dates and times of the determined program listing 40 are compared with the start and end dates and times of each set of equivalent program listings to determine an amount of overlap between the running time of the determined program listing 40 and each set of equivalent program listings 40.

Next, step 430 determines whether the amount of overlap between the determined program listing and one or more sets of equivalent program listings 40 overlap by more than a specified fraction (for example, 90%). If the amount of overlap between the program listing 40 and any set of equivalent program listings 40 does not exceed the specified fraction, then step 460 is processed.

However, if the amount of overlap between the determined program listing 40 and one or more sets of equivalent program listings 40 exceeds the specified fraction, then it is ascertained in step 440 whether the determined program listing 40 should be included in any of these sets. This is done by establishing whether the data items of the determined program listing 40 are similar enough to the data items of the equivalent program listings 40 of any one set, using the same analyses and techniques as described above with reference to step 330 of algorithm 300, to be considered equivalent and included in the set. If such analyses determine that the determined program listing 40 should be included in a set of equivalent program listings 40, then step 450 adds this program listing 40 to the set.

In step 460, it is determined whether there are any more program listings 40 whose start date and time fall within the scheduled time range, but not within any time window of algorithm 300. If this condition is met, the processing returns to step 410. Otherwise, the processing for algorithm 400 ends and the sets of equivalent program listings are sent to the combining unit 108. Any program listing 40 not included in a set of equivalent program listings 40 in algorithms 300 and 400, is treated as its own set of equivalent program listings 40.

As discussed above, after the identifying unit 106 identifies all sets of equivalent program listings, the combining unit 108 combines the best information for each set of equivalent program listings 40 into a single program listing 40 to be included in the generated EPG 10. In an embodiment of the present invention, the EPG generating device 100 further processes the program listings 40 of the generated EPG 10 to determine one or more categories for each program listing 40. The EPG generating device 110 may include a processing unit that extracts relevant keywords from the program titles and the program descriptions, as well as other data items, corresponding to each program listing 40. The EPG generating device 110 may then determine multiple categories for each program listing 40 based on these keywords.

For instance, a program listing 40, which has a program title called “Children's Singing Hour” may be included in a “children's shows” category, as well as a “singing” or “sing-along” category. In an embodiment, a user can search for programs based on these keyword-generated categories.

In one embodiment, the EPG output device 110 may supply the viewer, or user, with EPG information in alternative languages. For example, EPG information may be available in both Dutch and English. In such an embodiment, the EPG generating device 110 may include a language translation device, which translates the generated EPG 10 into a specified number of different languages. The user may be able to designate a specific language for which the generated EPG 10 is to be output.

In a further embodiment, the present invention may allow the user to designate a set of EPG data sources 120 to the EPG generating device 100, from which EPG data should be acquired whenever an EPG 10 is generated. The user would only need to designate these EPG sources 120 once, and a listing of the designated sources 120 is stored in a memory or data storage device within the acquiring unit 102 of the EPG generating device 100.

For example, the user may designate a group of URLs (uniform resource locator) of Internet web pages that contain EPG information corresponding to the user's geographical region and/or the television broadcast service to which the user subscribes. It is quite common for such Internet pages to include program listings 40 corresponding to one channel for the current day. The user may choose from a set of displayed URLs, which have been discovered in an Internet search performed by the EPG generating unit 100. Alternatively, the user may manually key in the URLs of websites containing EPG listings that are known to the user.

In a further embodiment, in addition to generating an EPG 10 from the EPG data acquired from a plurality of sources 120, the EPG generating device 100 may further generate an Internet portal (e.g., a HTML document or the like), which is displayed on the EPG output device 110 in conjunction with an Internet browsing application. The Internet portal may contain links to the URL of each EPG source 120 accessible on the Internet. According to a further embodiment, the Internet portal may contain links to only those URLs designated by a user. The generated Internet portal would allow a user to access the Internet page by clicking on the corresponding link.

The present invention is not limited to generating an EPG 10 from a plurality of sources. A plurality of different schedules may be generated according to the present invention. In one embodiment, the present invention may be used to generate a listing of scheduled theaters and show times for movies and plays from a plurality of different sources. In another embodiment, the present invention may generate a list of concert appearances for a touring music band or orchestra. Also, a schedule of sports events in a given area can be generated by the present invention. In particular, the present invention may be used to generate any list of scheduled events from data acquired from a plurality of sources.

The present invention has been described with reference to the embodiments described above. As will be evident to those skilled in the art, various modifications of this invention can be made or followed in the light of the foregoing disclosure without departing from the spirit and scope of the claims.

1. A system for generating and outputting electronic program guide (EPG) information the system comprising:
an acquiring unit (102) for acquiring EPG data from a plurality of sources (120), said EPG data including one or more program listings (40);
a storage device for storing said acquired EPG data;
an identifying unit (106) for identifying a set of equivalent program listings (40) from said stored EPG data, wherein each program listing in said set of equivalent program listings (40) has a scheduled starting time that falls within a specified time window;
a combining unit (108) for combining information from said set of equivalent program listings (40) to a single combined program listing (40);
an output device (110) for outputting an EPG including said combined program listing (40).

2. The system as claimed in claim 1, further comprising:
a second identifying unit for identifying program listings (40) from said stored EPG data, not included in said set of equivalent programming listings (40), which are judged to be equivalent to said program listings (40) in said set of equivalent program listings (40) and whose scheduled broadcast time overlaps, by more than a given fraction the scheduled broadcast time of each program listing (40) in said set of equivalent program listings (40),
wherein said combining unit (108) combines information from said program listings (40) identified by said second identifying unit with said information from said set of equivalent program listings (40) to said single combined program listing (40).

3. The system as claimed in claim 1, wherein said storage device writes said EPG data into a database (104).

4. The system as claimed in claim 1, wherein said plurality of sources (120) includes at least one remote source (120).

5. The system as claimed in claim 1, wherein said acquiring unit acquires EPG data from at least one of the Internet (122), teletext (126), Program and System Information Protocol (PSIP) data, and Digital Video Broadcasting Service Information (DVB-SI) (124).

6. The system as claimed in claim 1, wherein said combining unit (108) identifies conflicting data items in the information provided by two or more program listings (40) in said set of equivalent program listings (40), and
wherein said combining unit (108) chooses a data item from said conflicting data items to be included in said combined program listing (40) based predetermined criteria.

7. The system as claimed in claim 6, wherein said predetermined criteria includes at least one of amount of information, reliability of information, and appropriateness of the language of said conflicting data items.

8. The system as claimed in claim 1, wherein each program listing (40) included in said acquired EPG data includes at least one of a program title and a program description, and
wherein said program listings (40) can be sorted into a plurality of categories, said categories being defined at least in part in accordance with keywords extracted from said program title and/or said program description.

9. The system as claimed in claim 1, wherein said plurality of sources includes at least one Internet site, said system further comprising
an Internet portal generator that generates an Internet portal including links through which said at least one Internet site can be accessed.

10. A process for generating and outputting electronic program guide information (EPG) (10) the process comprising the steps of:
acquiring and storing EPG data from a plurality of sources (120), said EPG data including one or more program listings (40);
identifying a set of equivalent program listings (40) from said stored EPG data, wherein each program listing (40) in said set of equivalent program listings (40) has a scheduled starting time that falls within a specified time window;
combining information from said set of equivalent program listings (40) to a single combined program listing (40);
outputting an EPG (10) including said combined program listing (40).

11. A computer-readable medium including instructions to be executed on a computer, said medium comprising:
instructions for acquiring and storing EPG data from a plurality of sources (120), said EPG data including one or more program listings (40);
instructions for identifying a set of equivalent program listings (40) from said stored EPG data, wherein each program listing (40) in said set of equivalent program listings (40) has a scheduled starting time that falls within a specified time window;
instructions for combining information from said set of equivalent program listings (40) to a single combined program listing (40);
instructions for outputting an EPG (10) including said combined program listing (40).
